(19) United States
(12) Patent Application Publication
(10) Pub. No.: US 2025/0086373 A1
(43) Pub. Date: Mar. 13, 2025

(54) AUTOMATED INFERENCE AND EVALUATION OF DESIGN RELATIONS FOR ELEMENTS OF A DESIGN

(71) Applicant: ADOBE INC., San Jose, CA (US)

(72) Inventors: Vivek AGRAWAL, Noida (IN); Tarun BERI, Noida (IN); Nitesh DODEJA, Delhi (IN)

(21) Appl. No.: 18/466,597

(22) Filed: Sep. 13, 2023

(51) Int. Cl. G06F 40/103

(52) U.S. Cl. CPC G06F 40/103

(57) ABSTRACT

Methods and systems are provided for automated inference and evaluation of design relations for elements of a design. In embodiments described herein, a change, related to a type of design relation, is received to an element of a plurality of elements of a design. A corresponding type of design relation between the element and a different element of the plurality of elements is determined from a knowledge graph based on the type of design relation related to the change. A corresponding change is automatically applied to the different element based on the corresponding type of design relation between the element and the different element.

### BACKGROUND

Design applications, such as vector graphics editors, allow users of the applications to create and edit various types of designs, such as websites, logos, illustrations, icons, typography, etc. During the design process, design applications oftentimes have various tools to assist the end user of the design application. Examples of tools include assembly tools, such as align or distribute, which allows a user to select multiple elements and position the elements with respect to other elements in the design. In order to use the various tools of the design application, the user must manually select each element and the tool each time the user desires to utilize the tool to apply desired changes to the design.

### SUMMARY

Various aspects of the technology described herein are generally directed to systems, methods, and computer storage media for, among other things, automated inference and evaluation of design relations for elements of a design. In this regard, embodiments described herein facilitate automated inference and evaluation of design relations for elements of a design by automatically applying changes between elements of a design with inferred design relations. In this regard, by automatically applying changes between elements of a design with inferred design relations in an efficient and effective manner, the updating of a design following a change to an element of the design is optimized as the user is required to perform less manual operations to update the design. As described herein, a user changes element(s) of a design through a design application. For example, the user selects a number of elements of a design and applies an assembly change, such as align or distribute, an appearance change, such as color, font size, font effects, font style, and underline, and/or a markup change, such as a linear or angular measurement. A type of design relation based on the change to the element(s) is inferred and stored in a knowledge graph. For any subsequent change to an element(s), a corresponding change is automatically applied to other element(s) in the design based on type of design relation(s) between the element(s) and the other element(s) stored in the knowledge graph. For example, if a user moves a first element to a new position, and the first element is in an inferred alignment type of design relation with a second element, the second element is automatically aligned with the new position of the first element. When there are multiple design relations between multiple elements, a breadth first traversal algorithm is utilized to apply each corresponding change based on each design relation to all elements affected by a change to a design.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a diagram of an environment in which one or more embodiments of the present disclosure can be practiced, in accordance with various embodiments of the present disclosure.

FIG. 2 depicts an example configuration of an operating environment in which some implementations of the present disclosure can be employed, in accordance with various embodiments of the present disclosure.

FIG. 3 provides an example diagram of an example design showing automated inferred types of design relations between elements in order to apply the inferred types of design relations in response to changes to the design, in accordance with embodiments of the present disclosure.

FIG. 4A provides another example diagram of an example design showing user implemented changes that are utilized for automated inferred design relations between elements in order to apply the inferred types of design relations in response to changes to the design, in accordance with embodiments of the present disclosure.

FIG. 4B provides an example diagram of inferred design relations from changes to elements of the example design of FIG. 4A, in accordance with embodiments of the present disclosure.

FIG. 4C provides an example diagram of an example design showing changes to an element of the design FIG. 4A and applying the inferred types of design relations from FIG. 4B in response to the changes to the design, in accordance with embodiments of the present disclosure.

FIG. 5A provides an example diagram of automated application of the inferred types of design relations in response to changes to the design in one order, in accordance with embodiments of the present disclosure.

FIG. 5B provides an example diagram of automated application of the inferred types of design relations in response to changes to the design in a different order than the order of FIG. 5A, in accordance with embodiments of the present disclosure.

FIG. 6A provides another example diagram of an example design showing user implemented changes that are utilized for automated inferred design relations between elements in order to apply the inferred types of design relations in response to changes to the design, in accordance with embodiments of the present disclosure.

FIG. 6B provides an example diagram of inferred design relations from changes to elements of the example design of FIG. 6A, in accordance with embodiments of the present disclosure.

FIG. 6C provides an example diagram of an example design showing changes to an element of the design FIG. 6A and applying the inferred types of design relations from FIG. 6B in response to the changes to the design, in accordance with embodiments of the present disclosure.

FIG. 6D provides an example diagram showing an order in which the inferred types of design relations are applied in the example diagram of FIG. 6C, in accordance with embodiments of the present disclosure.

FIG. 7A provides an exemplary schematic screenshot from a personal computing device showing aspects of example graphical user interfaces with an example design showing automated inferred types of design relations between elements with respect to font attributes in order to apply the inferred types of design relations in response to changes to the design, in accordance with embodiments of the present disclosure.

FIG. 7B provides an exemplary schematic screenshot from a personal computing device showing aspects of example graphical user interfaces with the example design of FIG. 7A showing applying the inferred types of design relations from FIG. 7A in response to changes to the design, in accordance with embodiments of the present disclosure.

FIGS. 8A-C provide exemplary schematic screenshots from a personal computing device showing aspects of example graphical user interfaces with an example design showing automated inferred types of design relations between elements with respect to position/assembly in order to apply the inferred types of design relations in response to changes to the design, in accordance with embodiments of the present disclosure.

FIGS. 8D-E provide exemplary schematic screenshots from a personal computing device showing aspects of example graphical user interfaces with the example design of FIGS. 8A-C showing applying the inferred types of design relations from FIGS. 8A-C in response to changes to the design, in accordance with embodiments of the present disclosure.

FIGS. 9A-B provide exemplary schematic screenshots from a personal computing device showing aspects of example graphical user interfaces with an example design showing automated inferred types of design relations between elements with respect to color in order to apply the inferred types of design relations in response to changes to the design, in accordance with embodiments of the present disclosure.

FIGS. 9C-D provide exemplary schematic screenshots from a personal computing device showing aspects of example graphical user interfaces with the example design of FIGS. 9A-B showing applying the inferred types of design relations from FIGS. 9A-B in response to changes to the design, in accordance with embodiments of the present disclosure.

FIG. 10 is a process flow showing a method for automated inference and evaluation of design relations for elements of a design, in accordance with embodiments of the present disclosure.

FIG. 11 is a process flow showing another method for automated inference and evaluation of design relations for elements of a design, in accordance with embodiments of the present disclosure.

FIG. 12 is a process flow showing another method for automated inference and evaluation of design relations for elements of a design, in accordance with embodiments of the present disclosure.

FIG. 13 is a block diagram of an example computing device in which embodiments of the present disclosure can be employed.

### DETAILED DESCRIPTION

Design applications, such as vector graphics editors, allow users of the applications to create and edit various types of designs, such as websites, logos, illustrations, icons, typography, etc. During the design process, design applications oftentimes have various tools to assist the end user of the design application. Examples of tools include assembly tools, such as align or distribute, which allows a user to select multiple elements and position the elements with respect to other elements in the design. Another example of tool is an “eyedropper” tool, which allows a user to apply the appearance, such as color, from one element to another element. Yet another example of a tool is a markup tool, which allows a user to provide a measurement, such as linear or angular measurement, of an element in the design. In order to use the various tools of the design application, the user must manually select each element and the tool each time the user desires to utilize the tool to apply desired changes to the design.

Currently, in order to implement changes with respect to elements of a design in a design application, a user must manually select each element that the user desires to apply a desired change. Subsequently, when the user moves one of the elements or applies any type of new change to one of the elements that were previously selected, the user must then manually select all of the elements to apply the desired change. Oftentimes, a user will miss one of the elements of the previously selected elements to apply the new changes and will have to manually repeat the process. Not only is the manual process of repetitively selecting all of the elements a user desires to apply changes to time-consuming, the manual process unnecessarily increases the usage of computing and network resources.

Accordingly, unnecessary computing resources are utilized for implementing changes with respect to elements of a design in a design application in conventional implementations. For example, computing and network resources are unnecessarily consumed to facilitate the manual selection of each element a user desires to apply changes to in a design following a change to one of the elements of the selected elements. For instance, computer input/output operations are unnecessarily increased to manually select each element that a user desires to apply certain changes and/or repeating the process when the user misses one of the elements that the user desires to apply the changes. As one example, each time a user applies a change to a first element, where the change to first element requires the user to apply changes to different elements based on the change to the first element, the design must first be updated based on the change to the first element. In this regard, the information related to the updated design based on the change to first element must then be retrieved from the particular computer storage address of the storage device and presented to use in the design of the design application. The user reviews the results of the change to the first element and then must subsequently select each element that require the user to apply changes based on the change to the first element. The subsequent selection of the different elements must then be retrieved from the particular computer storage address of the storage device and presented to the user in the design of the design application. The user must then apply the changes to the different elements based on the change to the first element. The information related to the newly updated design based on the changes to the different elements must then be retrieved from the particular computer storage address of the storage device and presented to the user through the design application. Oftentimes, the user must repeat the process as the user may have missed one of the different elements that the user desires to apply changes based on the changes to the first element. Further, oftentimes the user may miss one of the desired changes to apply to the different elements based on changes to the first element (e.g., the user only applied alignment changes to the different elements, but did not apply a distribute changes to the different elements). As the user must perform multiple manual steps and oftentimes must repeat the multiple manual steps to apply corresponding changes to elements following a change to a first element in a design of a design application, computing resources are unnecessarily used in accessing, presentation and review process of the information related to the updated design in the design application following each manual step.

As such, embodiments of the present disclosure are directed to automated inference and evaluation of design relations for elements of a design in an efficient and effective manner. In this regard, elements of a design can be updated following a change to the design efficiently and effectively based on inferred design relations between elements of the design, thereby optimizing the design process.

Generally, and at a high level, embodiments described herein facilitate automated inference and evaluation of design relations for elements of a design by automatically inferring design relations and applying changes between elements of a design with inferred design relations. In this regard, by automatically applying changes between elements of a design with inferred design relations in an efficient and effective manner, the updating of a design following a change to an element of the design is optimized as the user is required to perform less manual operations to update the design. As described herein, a user changes (e.g., modifies) element(s) of a design through a design application. For example, the user selects a number of elements of a design and applies an assembly change, such as align or distribute, an appearance change, such as color, font size, font effects, font style, and underline, and/or a markup change, such as a linear or angular measurement. A type of design relation based on the change to the element(s) is inferred and stored in a knowledge graph. For any subsequent change (e.g., modification) to an element(s), a corresponding change is automatically applied to other element(s) in the design based on type of design relation(s) between the element(s) and the other element(s) stored in the knowledge graph. For example, if a user moves a first element to a new position, and the first element is in an inferred alignment type of design relation with a second element, the second element is automatically aligned with the new position of the first element. When there are multiple design relations between multiple elements, a breadth first traversal algorithm is utilized to apply each corresponding change based on each design relation to all elements affected by a change to a design.

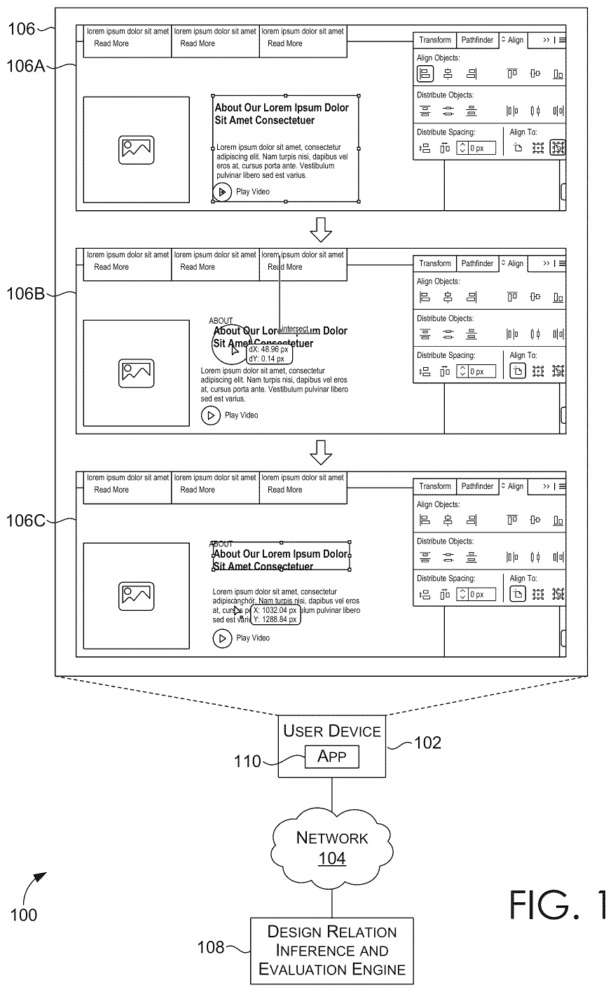

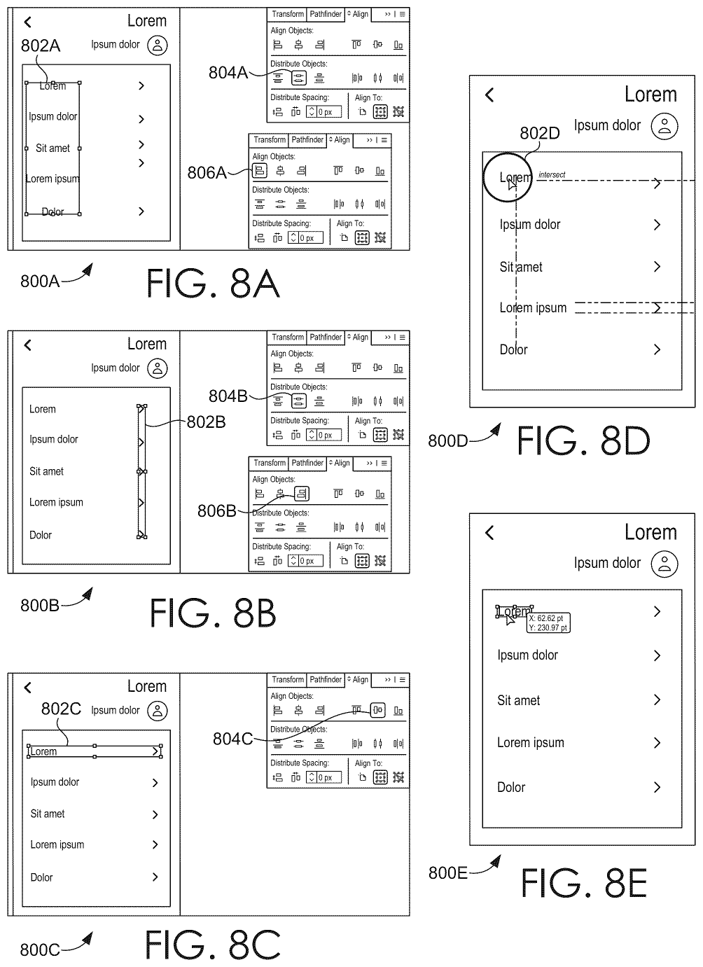

In operation, a user changes an element(s) of a design through a design application. For example, the user selects a number of elements of a design and applies an assembly change, such as align or distribute, to each of the number of elements. In order to apply an alignment change, the user selects two or more elements, selects the type of alignment (e.g., left align to align the left edge of the two or elements), which aligns each of the two or more elements with each other. Examples of an alignment change are shown in the examples of 106A of FIG. 1, 806A of FIG. 8A, and 806B of FIG. 8B. In order to apply a distribute change, the user selects three or more elements, selects distribute, which distributes the three or more elements evenly. Examples of a distribute change are shown in the examples of 804A of FIGS. 8A and 804B of FIG. 8B.

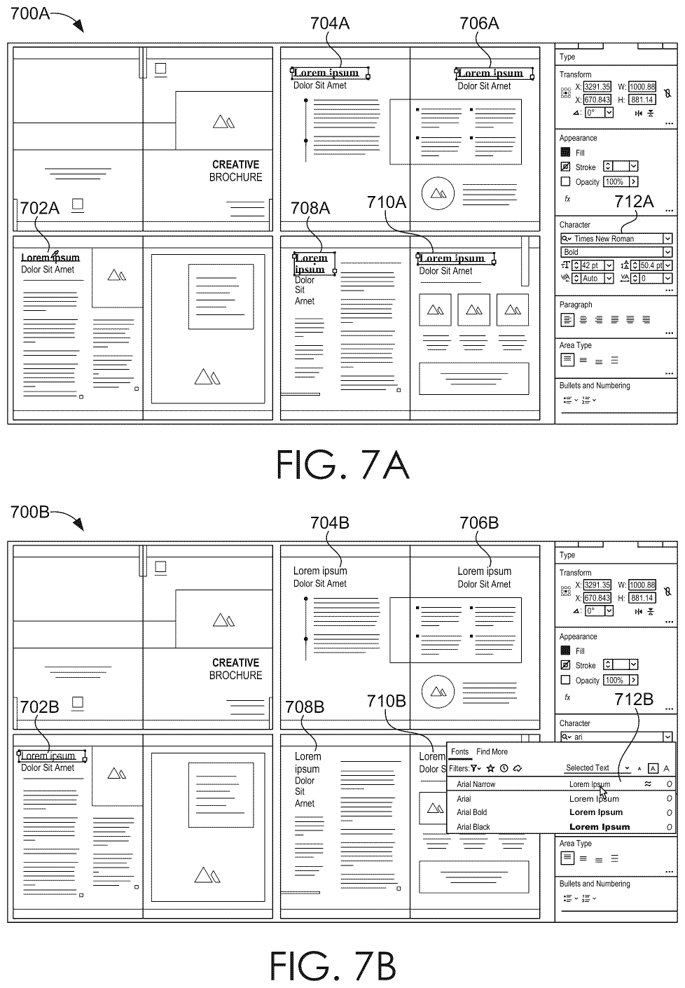

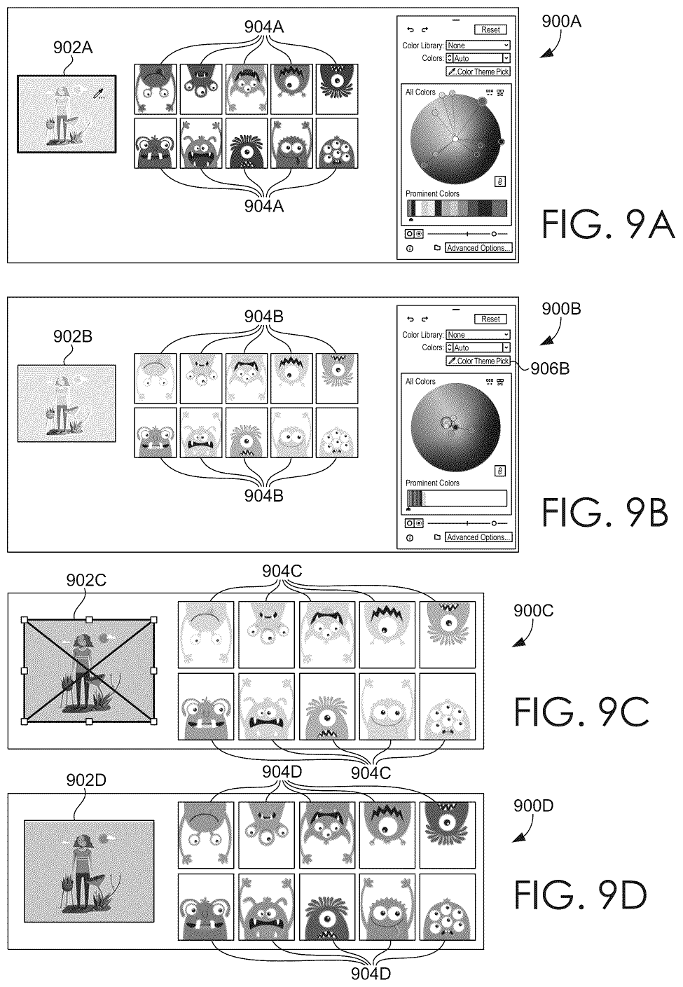

As another example, the user selects a number of elements of a design and applies an appearance change, such as color, font size, font effects, font style, underline, etc. to each of the number of elements. For example, as shown in the example of FIG. 7A, a user selects a number of titles for a design of a brochure, selects the type of font, which updates the font for each of the number of titles of the design of the brochure. As another example, as shown in the examples of FIGS. 9A and 9B, a user selects a number of drawings, selects a color for the number of drawings, which updates each of the drawings with the selected color.

As another example, the user selects a single element or a number of elements of a design and applies a markup change, such as a linear or angular measurement. For example, the user selects a single object to provide a measurement of the object or selects two or more objects to provide a linear or angular measurement between the two or more objects.

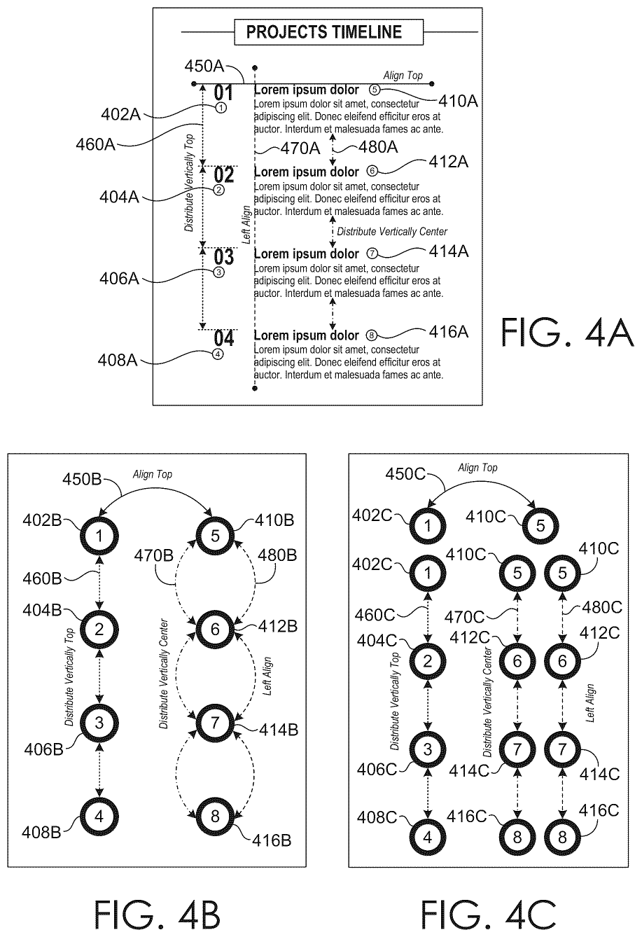

Based on the type of change to the element(s), a type(s) of design relation(s) is inferred and stored in a knowledge graph. For example, the user's changes (e.g., align, distribute, color and/or font attribute change, etc.) are stored as a corresponding type of design relation (e.g., a corresponding class edge) in the knowledge graph. In this regard, the knowledge graph stores each element as a node and each type of design relation an edge that is classified according to its corresponding type of design relation (e.g., as a class edge described with respect to FIGS. 4A-C, etc.). For example, as shown in the examples of FIG. 4B, the user selects a number of elements of a design and applies a distribute change to each of the number of elements. As shown in the examples of FIG. 4C, a distribute type of design relation between each of the number of elements is stored as the type of design relation between each of the number of elements.

For any subsequent change to an element(s), a corresponding change can be applied to other element(s) in the design based on type of design relation(s) between the element(s) and the other element(s) stored in the knowledge graph. For example, if a user moves a first element to a new position (e.g., 106B of FIG. 1), and the first element is in an inferred alignment type of design relation with a second element (e.g., based on the change applied in 106A of FIG. 1), the second element is automatically aligned with the new position of the first element (e.g., 106C of FIG. 1).

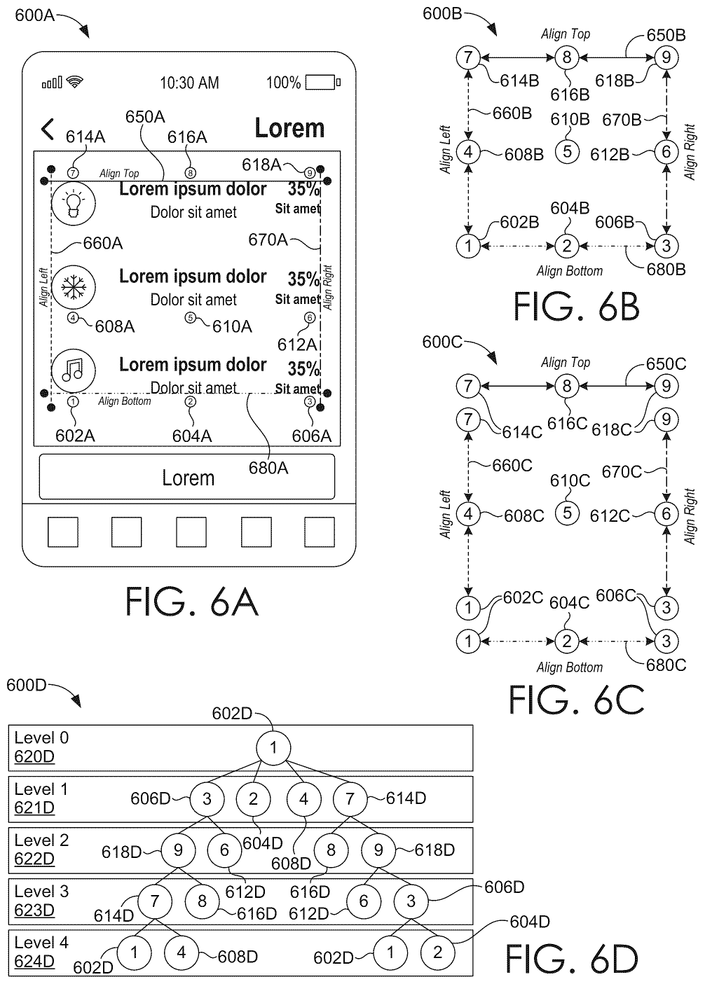

When there are multiple design relations between multiple elements, a breadth first traversal algorithm can be used to apply each corresponding change based on each design relation to all elements affected by a change to a design. For example, as shown in the examples of FIGS. 6A-6D, following a change to a first element, corresponding changes are applied to a first set of elements connected to the first element based on the design relations between the first element and the first set of elements (e.g., level 1 604D). In this regard, the corresponding changes to the first set of elements are evaluated in their entirety before proceeding to subsequent changes (e.g., level 2 606D). Subsequently, corresponding changes are applied to a second set of elements connected to the first set of elements based on the design relations between the first set of elements and the second set elements (e.g., level 2 606D). In this regard, the corresponding changes to the second set of elements are evaluated in their entirety before proceeding to subsequent changes (e.g., level 3 608D). Finally, upon encountering the first element (e.g., level 4 610D), the cycle of the algorithm ends (e.g., poor man's cycle breaking).

In some embodiments, when multiple changes are made simultaneously by a user, the first element to be evaluated is selected at random. In some embodiments, when corresponding changes conflict based on types of design relations stored for elements, the corresponding change of a corresponding type of design relation with a higher priority is applied. For example, a user changes the font size of an element, and the element is connected by align type of design relations and distribute type of design relations with other objects. In some instances, the align type of design relations and the distribute type of design relations may not be able to reconcile. In this regard, a distribute type of design relation may be set at a higher priority, so that the align type of design relation is rendered invalid, to maintain the validity of the distribute type of design relation. In some embodiments, the user can adjust the priorities of the various types of relations in the design application.

In some embodiments, a designer can turn off the functionality for automated application of inferred types of design relations to objects. As an example, a user can hold a modifier key (e.g., command key, control key, etc.) to explicitly break one or more relations while making design changes. For example, if a first element is in an alignment type of design relation with a second element, and the user holds the modifier key while moving the first element to a new position, the second element will remain in its original position and will not be automatically aligned to the new position of the first element.

Advantageously, efficiencies of computing and network resources can be enhanced using implementations described herein. In particular, following a change(s) to an element(s) of a design in a design application, automatically applying a corresponding change(s) to a different element(s) based on type(s) of design relation(s) inferred between the element and the different element provides for a more efficient use of computing resources (e.g., reduced computer input/output operations, higher throughput and reduced latency for a network, less packet generation costs, etc.) than conventional methods of manually applying changes to each element of a design that a user desires to apply changes following a change to one element of the design. In this regard, the technology described herein enables the automatic applying of changes between elements of a design with inferred design relations in an efficient and effective manner, thereby reducing unnecessary computing resources used to process the accessing, presentation and review of the information related to the updated design in the design application following each manual step of updating elements of a design. The technology described herein results in less input/output operations, less information over a computer network, which results in higher throughput, reduced latency, less packet generation costs as fewer packets are sent over a network, etc. Therefore, the technology described herein conserves computing and network resources.

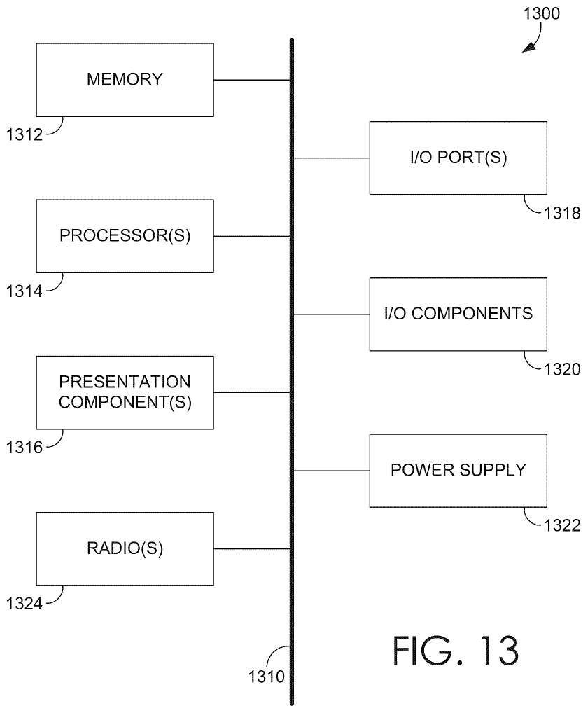

Turning to the figures, FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 13.

It should be understood that operating environment 100 shown in FIG. 1 is an example of one suitable operating environment. Among other components not shown, operating environment 100 includes a user device 102, application 110, network 104, and design relation inference and evaluation engine 108. Operating environment 100 also shows an example 106 showing user implemented changes in a design that are utilized for automated inferred design relations between elements in order to apply the inferred types of design relations in response to changes to the design. Example 106 includes an example 106A of user-implemented changes to automatically infer an align type of design relation between elements of a design, an example 106B of receiving a subsequent change to an element with an inferred align type of design relation, and an example 106C of automatically applying corresponding changes to each element with an inferred align type of design relation based on the subsequent change. Each of the components shown in FIG. 1 can be implemented via any type of computing device, such as one or more of computing device 1300 described in connection to FIG. 13, for example.

These components can communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, one or more private networks, one or more cellular networks, one or more peer-to-peer (P2P) networks, one or more mobile networks, or a combination of networks. Where network 104 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 104 is not described in significant detail.

It should be understood that any number of user devices, servers, and other components can be employed within operating environment 100 within the scope of the present disclosure. Each can comprise a single device or multiple devices cooperating in a distributed environment.

User device 102 can be any type of computing device capable of being operated by an individual(s) (e.g., a designer, artist or any user that edits designs, artwork, documents, etc.). For example, in some implementations, such devices are the type of computing device described in relation to FIG. 13. By way of example and not limitation, user devices can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media may include computer-readable instructions executable by the one or more processors. The instructions may be embodied by one or more applications, such as application 110 shown in FIG. 1. Application 110 is referred to as single applications for simplicity, but its functionality can be embodied by one or more applications in practice.

Application 110 operating on user device 102 can generally be any application capable of displaying designs, such as a vector graphics application for the design of logos, icons, drawings, typography, complex illustrations, etc. In some implementations, the application 110 comprises a web application, which can run in a web browser, and could be hosted at least partially server-side (e.g., via design relation inference and evaluation engine 108). In addition, or instead, the application 110 can comprise a dedicated application. In some cases, the application 110 is integrated into the operating system (e.g., as a service). As specific example applications, application 110 may be a graphics (e.g., vector graphics, raster graphics, etc.) design website or application, a digital drawing website or application, a digital graphics editor website or application, a presentation design and/or editor website or application, or any website or application that is capable of using or displaying images and/or video. Such an application may be accessed via a mobile application, a web application, or the like.

User device 102 can be a client device on a client-side of operating environment 100, while design relation inference and evaluation engine 108 can be on a server-side of operating environment 100. Design relation inference and evaluation engine 108 may comprise server-side software designed to work in conjunction with client-side software on user device 102 so as to implement any combination of the features and functionalities discussed in the present disclosure. An example of such client-side software is application 110 on user device 102. This division of operating environment 100 is provided to illustrate one example of a suitable environment, and it is noted there is no requirement for each implementation that any combination of user device 102 or design relation inference and evaluation engine 108 to remain as separate entities.

Application 110 operating on user device 102 can generally be any application capable of facilitating the exchange of information between the user device 102 and the design relation inference and evaluation engine 108 in displaying and exchanging information regarding a design and the editing of the design. In some implementations, the application 110 comprises a web application, which can run in a web browser, and could be hosted at least partially on the server-side of environment 100. In addition, or instead, the application 110 can comprise a dedicated application. In some cases, the application 110 is integrated into the operating system (e.g., as a service). It is therefore contemplated herein that “application” be interpreted broadly.

At a high level, design relation inference and evaluation engine 108 performs various functionality to facilitate efficient and effective automated inference and evaluation of design relations for elements of a design. The design relation inference and evaluation engine 108 can communicate with application 110 in order for application 110 to display the design, receive changes from tools to edit/change the design (e.g., alignment tools, distribute tools, font change tools, etc.), automatically update the design based on inferred design relations stored between elements of the design, and display the edited/updated design via a display screen of the user device 102. In this regard, design relation inference and evaluation engine 108 can receive data regarding the design from application 110 of the user device.

An example of automated inferred design relations between elements in order to apply the inferred types of design relations in response to changes to the design is shown as example 106. In operation, a design with a number of elements is displayed via a graphical user interface provided via the application 110. For example, examples 106A-C show a number of text elements of a design. Along with the number of text elements of the design 106A, the user interface (UI) shows a number of tools to edit the design. As can be understood, any amount and types of tools for editing a design are within the scope of the present disclosure.

In the example 106A, the user can select a number of elements (e.g., the three text elements) and the user makes changes to elements of the design (e.g., the user selects the left vertical align tool to vertically align the left edge of the elements). Design relation inference and evaluation engine 108 infers a type of design relation between the elements based on the user-implemented changes to the design (e.g., design relation inference and evaluation engine 108 infers a left vertical align type of design relation between the three text elements). In embodiments, a knowledge graph stores each element as a node and each type of design relation an edge that is classified according to its corresponding type of design relation.

In the example 106B, subsequent to the automated inference of the type(s) of design relation(s) between the elements (e.g., as described with respect to example 106A), the user selects at least one of the elements to change the design (e.g., the user moves one of the three text elements to a new a position in example 106B). In the example 106C, a corresponding change can be applied to other element(s) in the design based on the type of design relation(s) between the element(s) and the other element(s) stored in the knowledge graph. For example, as can be understood from examples 106B and 106C, after the user moves one of the three text elements to a new a position in example 106B, the remaining text elements in a left vertical align type of design relation between the text elements are automatically left vertically aligned to the new position of the text element moved by the user. In this regard, elements of a design can be updated following a change to the design efficiently and effectively based on inferred design relations between elements of the design, thereby optimizing the design process as the user is required to perform less manual operations to update the design.

Any amount of types of design relations can be inferred between any amounts of elements based on any amount of user-implemented changes to a design. Various examples of automated inference and evaluation of design relations for elements of a design are provided in FIGS. 4A-9D.

Thus, design relation inference and evaluation engine 108 performs various functionality to facilitate efficient and effective automated inference and evaluation of design relations for elements of a design. The design relation inference and evaluation engine 108 can communicate with application 110 in order for application 110 to display the design, receive changes from tools to edit/change the design, automatically update the design based on inferred design relations stored between elements of the design, and display the edited/updated design via a display screen of the user device 102. In this regard, design relation inference and evaluation engine 108 can receive data regarding the design from application 110 of the user device.

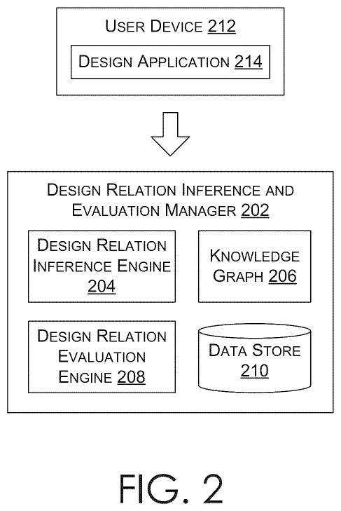

Design relation inference and evaluation engine 108 can be or include a server, including one or more processors, and one or more computer-readable media. The computer-readable media includes computer-readable instructions executable by the one or more processors. The instructions can optionally implement one or more components of design relation inference and evaluation engine 108, described in additional detail below with respect to image/video editing manager 202 of FIG. 2.

For cloud-based implementations, the instructions on design relation inference and evaluation engine 108 can implement one or more components, and application 110 can be utilized by a user to interface with the functionality implemented on design relation inference and evaluation engine 108. In some cases, application 110 comprises a web browser. In other cases, design relation inference and evaluation engine 108 may not be required. For example, the components of design relation inference and evaluation engine 108 may be implemented completely on a user device, such as user device 102. In this case, design relation inference and evaluation engine 108 may be embodied at least partially by the instructions corresponding to application 110.

Thus, it should be appreciated that design relation inference and evaluation engine 108 may be provided via multiple devices arranged in a distributed environment that collectively provide the functionality described herein. Additionally, other components not shown may also be included within the distributed environment. In addition, or instead, design relation inference and evaluation engine 108 can be integrated, at least partially, into a user device, such as user device 102. Furthermore, design relation inference and evaluation engine 108 may at least partially be embodied as a cloud computing service.

Referring to FIG. 2, aspects of an illustrative design relation inference and evaluation management system are shown, in accordance with various embodiments of the present disclosure. At a high level, design relation inference and evaluation management system can facilitate automated inference and evaluation of design relations for elements of a design by automatically inferring design relations and automatically applying changes between elements of a design with inferred design relations.

As shown in FIG. 2, design relation inference and evaluation manager 202 includes design relation inference engine 204, knowledge graph 206, and design relation evaluation engine 208. A user edits a design through design application 214 (e.g., application 110 of FIG. 1, such as a graphics (e.g., vector graphics, raster graphics, etc.) design website or application, a digital drawing website or application, a digital graphics editor website or application, a presentation design and/or editor website or application, etc.) on user device 212 (e.g., user device 102 of FIG. 1). The design relation inference and evaluation manager 202 facilitates automated inference and evaluation of design relations for elements of a design by automatically inferring design relations and applying changes between elements of a design with inferred design relations for presentation through design application 214 on user device 212. The design relation inference and evaluation manager 202 can communicate with the data store 210. The data store 210 is configured to store various types of information accessible by design relation inference and evaluation manager 202, or other server or component. The foregoing components of design relation inference and evaluation manager 202 can be implemented, for example, in operating environment 100 of FIG. 1. In particular, those components may be integrated into any suitable combination of user devices 102 and/or design relation inference and evaluation engine 108.

In embodiments, data sources, user devices (such as user device 102 of FIG. 1), and design relation inference and evaluation manager 202 can provide data to the data store 210 for storage, which may be retrieved or referenced by any such component. As such, the data store 210 can store computer instructions (e.g., software program instructions, routines, or services), data and/or models used in embodiments described herein, such as classifying user-implemented changes as types of design relations, editing elements of a design, and/or the like. In some implementations, data store 210 can store information or data received or generated via the various components of design relation inference and evaluation manager 202 and provides the various components with access to that information or data, as needed. The information in data store 210 may be distributed in any suitable manner across one or more data stores for storage (which may be hosted externally).

The design relation inference engine 204 is generally configured to infer types of design relations between elements from user-implemented changes to a design. In embodiments, design relation inference engine 204 can include rules, conditions, associations, models, algorithms, or the like to infer types of design relations between elements from user-implemented changes to a design. For example, design relation inference engine 204 may comprise a statistical model, fuzzy logic, neural network, finite state machine, support vector machine, logistic regression, clustering, or machine-learning techniques, similar statistical classification processes, or combinations of these to infer types of design relations between elements from user-implemented changes to a design.

In embodiments, a user implements changes to a design (e.g., examples of user-implemented changes to a design are described with respect to example 106A of FIG. 1, FIGS. 4A, 6A, 7A, 8A-C, 9A-B, etc.). Design relation inference engine 204 infers the user-implemented change to the design as a type of design relation. For example, design relation inference engine 204 classifies the user-implemented change to a number of elements of the design as a type of design relation between the number of elements in order to store the type of design relation between the number of elements in knowledge graph 206.

The knowledge graph 206 is generally configured to store types of design relation inferred between elements by design relation inference engine 204. The knowledge graph 206 can include rules, conditions, associations, models, algorithms, or the like to store relationships between elements. In embodiments, the knowledge graph 204 stores each element as a node and each type of design relation an edge that is classified according to its corresponding type of design relation. For example, as shown in the examples of FIG. 4B, the user selects a number of elements of a design and applies a distribute change to each of the number of elements. As shown in the examples of FIG. 4C, a distribute type of design relation between each of the number of elements is stored as an edge between each of the number of elements as nodes.

The design relation evaluation engine 208 is generally configured to automatically apply a corresponding change(s) to element(s) in the design based on a type of design relation(s) between elements stored in the knowledge graph. In embodiments, design relation evaluation engine 208 can include rules, conditions, associations, models, algorithms, or the like to automatically apply a corresponding change(s) to element(s) in the design. For example, design relation evaluation engine 208 may comprise a statistical model, fuzzy logic, neural network, finite state machine, support vector machine, logistic regression, clustering, or machine-learning techniques, similar statistical classification processes, or combinations of these to automatically apply a corresponding change(s) to element(s) in the design.

In embodiments, design relation evaluation engine 208 evaluates the types of design relationships between elements following a change to the design. In this regard, following a change to an element(s) of a design, design relation evaluation engine 208 applies a corresponding change(s) other element(s) in the design based on type of design relation(s) between the element(s) and the other element(s) stored in the knowledge graph 206. For example, if a user moves a first element to a new position (e.g., 106B of FIG. 1), and the first element is in an inferred alignment type of design relation with a second element (e.g., based on the change applied in 106A of FIG. 1), the second element is automatically aligned with the new position of the first element (e.g., 106C of FIG. 1).

In some embodiments, when there are multiple design relations between multiple elements, design relation evaluation engine 208 applies a breadth first traversal algorithm of knowledge graph 206 to apply each corresponding change based on each design relation to all elements affected by a change to a design. For example, as shown in the examples of FIGS. 6A-6D, following a change to a first element, corresponding changes are applied to a first set of elements connected to the first element based on the design relations between the first element and the first set of elements (e.g., level 1 604D). In this regard, the corresponding changes to the first set of elements are evaluated in their entirety before proceeding to subsequent changes (e.g., level 2 606D). Subsequently, corresponding changes are applied to a second set of elements connected to the first set of elements based on the design relations between the first set of elements and the second set elements (e.g., level 2 606D). In this regard, the corresponding changes to the second set of elements are evaluated in their entirety before proceeding to subsequent changes (e.g., level 3 608D). Finally, upon encountering the first element (e.g., level 4 610D), the cycle of the algorithm ends (e.g., poor man's cycle breaking).

In embodiments, the user-implemented change of an element is treated as the final change by design relation evaluation engine 208. For example, if a user moves a first element to a new position, any type of design relation between the first element and other elements is evaluated considering the new position of the first element as the final position of the first element following evaluation.

In some embodiments, when multiple changes are made simultaneously by a user, design relation evaluation engine 208 determines the first element to be evaluated at random. In some embodiments, when corresponding changes conflict based on types of design relations stored for elements, design relation evaluation engine 208 applies the corresponding change of a corresponding type of design relation with a higher priority and renders the type of design relation with a lower priority invalid. For example, a user changes the font size of an element, and the element is connected by align type of design relations and distribute type of design relations with other objects. In some instances, the align type of design relations and the distribute type of design relations may not be able to reconciled. In this regard, a distribute type of design relation may be set at a higher priority, so that the align type of design relation is rendered invalid, to maintain the validity of the distribute type of design relation. In some embodiments, the user can adjust the priorities of the various types of relations in the design application through design application 214.

In some embodiments, a user can turn off the functionality for the automated applying of inferred types of design relations to objects through design application 214. As an example, a user can hold a modifier key (e.g., command or control key) to explicitly break one or more relations while making design changes through design application 214. For example, if a first element is in an alignment type of design relation with a second element, and the user holds the modifier key while moving the first element to a new position, the second element will remain in its original position and will not be automatically aligned to the new position of the first element.

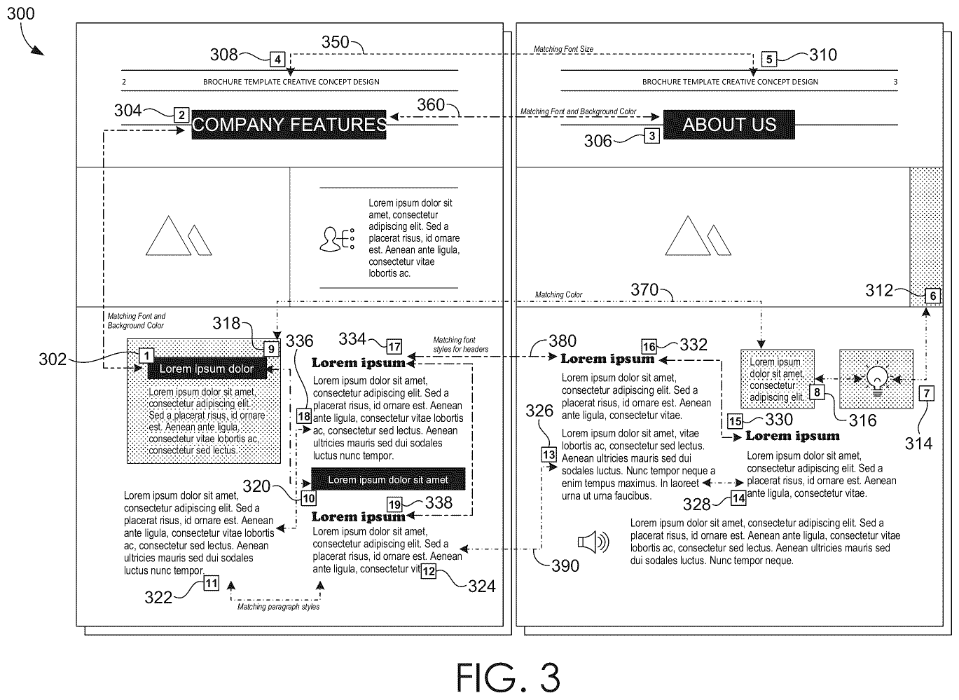

FIG. 3 provides an example diagram of an example design showing automated inferred types of design relations between elements in order to apply the inferred types of design relations in response to changes to the design, in accordance with embodiments of the present disclosure. As described herein, such inferred types of design relations between elements can be used to automatically apply changes based on the inferred types of design relations in response to changes of the design in an efficient and effective manner. Diagram 300 is an example diagram of an example design showing automated inferred types of design relations between elements.

As shown, each of elements 302, 304, 306, 308, 310, 312, 314, 316, 318, 320, 322, 324, 326, 328, 330, 332, 334, 336, 338 include inferred types of design relations 350, 360, 370, 380, 390 stored in a knowledge graph. For example, element 1 302, element 2 304, and element 3 306 include an inferred types of design relations 350 of matching font and background color. Element 4 308 and element 5 310 include an inferred type of design relation 360 of matching font size. Element 6 312, element 7 314, element 8 316, and element 9 318 include an inferred type of design relation 370 of matching color. Element 10 320, element 11 322, element 12 324, element 13 326, element 14 328, and element 18 336 include an inferred type of design relation 380 of matching paragraph styles. Element 15 330, element 16 332, element 17 334, and element 19 338 include an inferred type of design relation 390 of matching font style for headers.

In this regard, any change to one of the elements 302, 304, 306, 308, 310, 312, 314, 316, 318, 320, 322, 324, 326, 328, 330, 332, 334, 336, 338 would automatically cause a corresponding change to other element(s) based on the inferred type(s) of design relation(s) between the elements. Thus, users (e.g., designers) do not need to manually adjust each element each time the user desires to make a change.

FIG. 4A provides another example diagram of an example design showing user implemented changes that are utilized for automated inferred design relations between elements in order to apply the inferred types of design relations in response to changes to the design, in accordance with embodiments of the present disclosure. As described herein, such inferred types of design relations between elements can be used to automatically apply changes based on the inferred types of design relations in response to changes of the design in an efficient and effective manner. Diagram 400A is an example diagram of an example design showing automated inferred types of design relations between elements.

As shown, the example design of diagram 400A includes element 1 402A, element 2 404A, element 3 406A, element 4 408A, element 5 410A, element 6 412A, element 7 414A, and element 8 416A. Element 1 402A and element 5 410 include a user implemented change 450A of align top, which aligns the top edges of the elements. Element 1 402A, element 2 404A, element 3 406A, and element 4 408A include a user implemented change 460A of distribute vertically top, which distributes each elements with respect to the top edge of the element. Element 5 410A, element 6 412A, element 7 414A, and element 8 416A include two user implemented changes: user implemented change 470A of distribute vertically center, which distributes each elements with respect to the center of the element and user implemented change 480A of left align, which aligns the left edge of each of the elements.

FIG. 4B provides an example diagram of inferred design relations from changes to elements of the example design of FIG. 4A, in accordance with embodiments of the present disclosure. As described herein, such inferred types of design relations between elements can be used to automatically apply changes based on the inferred types of design relations in response to changes of the design in an efficient and effective manner. Diagram 400B is an example diagram showing automated inferred types of design relations between elements of diagram 400A of FIG. 4A.

As shown, node 1 402A, node 2 404A, node 3 406A, node 4 408A, node 5 410A, node 6 412A, node 1 414A, and node 8 416A corresponds to element 1 402A, element 2 404A, element 3 406A, element 4 408A, element 5 410A, element 6 412A, element 7 414A, and element 8 416A of FIG. 4A, respectively. As the user implements changes to the design of FIG. 4A through the change 450A of align top, change 460A of distribute vertically top, change 470A of distribute vertically center and change 480A of left align, corresponding types of design relations 450B, 460B, 470B and 480B are inferred. The types of design relations 450B, 460B, 470B and 480B are stored as edges between nodes 402B, 404B, 406B, 408B, 410B, 412B, 414B and 416B in a knowledge graph.

FIG. 4C provides an example diagram of an example design showing changes to an element of the design FIG. 4A and applying the inferred types of design relations from FIG. 4B in response to the changes to the design, in accordance with embodiments of the present disclosure. As described herein, automatically applying changes based on the inferred types of design relations in response to changes of the design is performed in an efficient and effective manner. Diagram 400C is an example diagram showing automated application of inferred types of design relations in response to change to elements of the design of diagram 400A of FIG. 4A.

As shown, as the user moves element 1 402C (e.g., element 1 402A of FIG. 4A), corresponding changes are applied to each of the elements 404C, 406C, 408C, 410C, 412C, 414C and 416C based on the type of design relation 450C, 460C, 470C and 480C (e.g., 450B, 460B, 470B and 480B of FIG. 4B, respectively) stored in the knowledge graph.

In embodiments, a knowledge graph of nodes and class edges is utilized express the network of relationships in a design. For example, every node in the graph stands for a vector design element of a design in a vector design application. A class edge represents a type of design relation. Thus, if n nodes are in an alignment type of design relation, n−1 bidirectional class edges are created to represent the alignment type of design relation. Similarly, if n nodes are in a distribute type of design relation, n−1 bidirectional class edges are created to represent the distribute type of design relation.

In some embodiments, class edges are created by connecting a first node to all others. In some embodiments, class edges are created by connecting every consecutive pair of nodes. In some embodiments, n class edges are created (e.g., instead of n−1 class edges).

In some embodiments, the types of design relations between elements can be a pair-wise relationship or a categorical relationship. A pair-wise relationship is a type of inter-element relationship that can be defined and evaluated with a pair of elements. In this regard, pair-wise relationships involve only two elements and can be evaluated based on the relationship between those two elements alone. Examples of pair-wise relationships include the alignment of two or more elements. In this regard, pair-wise relationships can be evaluated by considering any two elements at a time. With respect to pair-wise relationships, if one participating element is deleted or removed, the remaining pair-wise relationships between other elements still retain their validity.

Categorical relationships is a type of inter-element relationship that can be defined and evaluated with at least three or more elements. In this regard, a categorical relationship involves more than two elements and cannot be evaluated based on the relationship between just two elements. Examples of categorical relationships include the distribution of elements. In this regard, categorical relationship can be evaluated by evaluating all the affected elements together. With respect to categorical relationships, if an element is deleted or removed and the number of remaining elements falls below the minimum required (e.g., less than three elements), the entire categorical relationship is invalid.

In some embodiments, class edges provide graph cuts, which are small localized clusters to which updates can be limited during re-evaluation of design relations stored in a knowledge graph. In some embodiments, multiple class edges might need re-evaluation per update. For example, all class edges that control position (e.g., align, distribute, etc.) must be re-evaluated for positional updates (e.g., after a user changes the position of an element). In some embodiments, class edges that control position sometimes also depend upon class edge types that do no control position (e.g., appearance, such as font size). For example, a change to a font size of an element can indirectly affect the position of the element. In this case, class edges that control position must be re-evaluated. In some embodiments, class edges that control appearance do not affect the position of an element or other class edges controlling different appearance parameters, thus changes to appearance will not result in evaluated of class edges that control position or the other class edges controlling different appearance parameters. For example, if a user updates a font size of an element, the class edges that control the font do not need be re-evaluated.

In some embodiments, an element might participate in multiple design relations. For example, five elements may include a same font type of design relation. The five elements may also be in a markup type of design relation with other elements in order to display linear or angular measurement of the elements. In this example, if the designer (e.g., user) adjusts font of one of the five elements, only the network that carries font relation will be re-evaluated as there is no change expected for the markup type of design relation. Similarly, if markups are changed, no re-evaluations are required for font type of design relation. As a different example, if the five elements are in a horizontal center align type of design relation with each other, and one of the five elements is also in a vertical left align type of design relation with two separate elements, a positional change to any of the seven elements would require re-evaluations of both types of design relationships (e.g., the horizontal center align type of design relation and the vertical left alight type of design relation). In this regard, the traversal of class edges provides graph cuts, which allows updates to be limited to specific graph cuts based on the type of change, thereby optimizing performance so that updates to the design can be automatically performed in real-time.

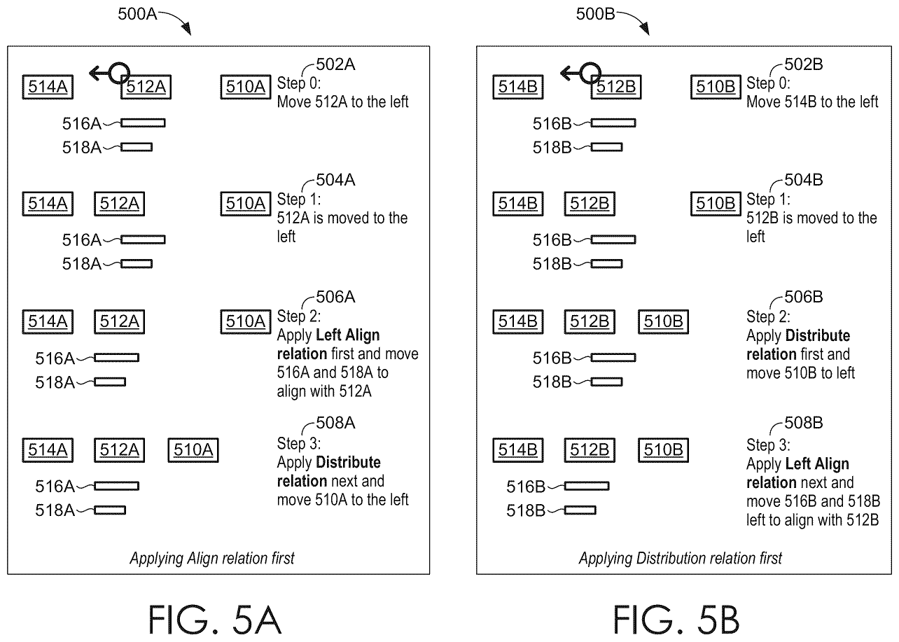

FIG. 5A provides an example diagram of automated application of the inferred types of design relations in response to changes to the design in one order, in accordance with embodiments of the present disclosure. FIG. 5B provides an example diagram of applying the inferred types of design relations in response to changes to the design in a different order than the order of FIG. 5A, in accordance with embodiments of the present disclosure.

As shown, diagram 500A of FIG. 5A is an example diagram of an example design showing automated application of the inferred types of design relations in response to changes to the design in one order. Diagram 500B of FIG. 5B is an example diagram of an example design showing automated application of the inferred types of design relations in response to changes to the design in a different order than the order of diagram 500A of FIG. 5A.

As shown, in both diagram 500A and 500B, inferred types of design relations are stored between each of the elements based on previous user design changes. Namely, a distribute type of design relation is stored in a knowledge graph between elements 510A, 512A and 514A of FIG. 5A (and corresponding elements 510B, 512B and 514B of FIG. 5B). As well, a left-align type of design relation is stored in a knowledge graph between elements 512A, 516A and 518A of FIG. 5A (and corresponding elements 512B, 516B and 518B of FIG. 5B).

Turning to FIG. 5A, at step 502A, element 512A is selected. At step 504A, element 512A is moved to the left. In response, at step 506A, the left align type of design relation between elements 512A, 516A and 518A is applied first. Subsequently, at step 508A, the distribute type of design relation between elements 510A, 512A and 514A is applied.

Turning to FIG. 5B, at step 502B, element 512B is selected. At step 504B, element 512B is moved to the left. In response, at step 506B, the distribute type of design relation between elements 510B, 512B and 514B is applied first. Subsequently, at step 508B, the left align type of design relation between elements 512B, 516B and 518B is applied.

As can be understood from FIGS. 5A and 5B, the order in which design relations are applied from an element to other elements connected to the element through a design relation (e.g., the node corresponding to an element is directly connected to another node of a different design element through an edge corresponding to a design relation in knowledge graph) is order agnostic in that the final result is the same. However, as described with respect to FIG. 6A-6D, in some embodiments, the order in which design relations are applied may be dependent on order.

In embodiments, the user's action with respect to an element (e.g., the movement of element 512A in FIGS. 5A and 512B in FIG. 5B) is treated as the final state of the element. In this regard, the user's input is treated as final position/setting of the changed element and other design elements are updated to match to this latest setting based on the types of design relations stored in the knowledge graph between the elements. In some embodiments, when a user changes multiple elements together (e.g., both element 512A and element 510A are moved asymmetrically), it may not be possible to maintain final position of the multiple elements based on the types of design relations stored between the elements. In some embodiments, an automatic arbitration that maintains user inputs as much as possible is utilized. For example, if both element 512A and element 510A are moved asymmetrically, and it is not possible to maintain the final position of both elements, the final position of either element 512A or element 510A is chosen (e.g., randomly chosen or based on a total amount of changes to other elements of the design) through automatic arbitration. In some embodiments, an option to break (and delete) the affected types of design relations is presented to an end user when it is not possible to maintain the final position of both elements.

FIG. 6A provides another example diagram of an example design showing user implemented changes that are utilized for automated inferred design relations between elements in order to apply the inferred types of design relations in response to changes to the design, in accordance with embodiments of the present disclosure. As described herein, such inferred types of design relations between elements can be used to automatically apply changes based on the inferred types of design relations in response to changes of the design in an efficient and effective manner. Diagram 600A is an example diagram of an example design showing automated inferred types of design relations between elements.

As shown, the example design of diagram 600A includes element 1 602A, element 2 604A, element 3 606A, element 4 608A, element 5 610A, element 6 612A, element 7 614A, element 8 616A, and element 9 618A. Element 1 602A, element 2 604A, and element 3 606A include a user implemented change 680A of align bottom, which aligns the bottom edges of the elements. Element 3 606A, element 6 612A, and element 9 618A include a user implemented change 670A of align right, which aligns the right edges of the elements. Element 1 602A, element 4 608A, and element 7 614A include a user implemented change 660A of align left, which aligns the left edges of the elements. Element 7 614A, element 8 616A, and element 9 618A include a user implemented change 650A of align top, which aligns the top edges of the elements.

FIG. 6B provides an example diagram of inferred design relations from changes to elements of the example design of FIG. 6A, in accordance with embodiments of the present disclosure. As described herein, such inferred types of design relations between elements can be used to automatically apply changes based on the inferred types of design relations in response to changes of the design in an efficient and effective manner. Diagram 600B is an example diagram showing automated inferred types of design relations between elements of diagram 600A of FIG. 6A.

As shown, node 1 602A, node 2 604A, node 3 606A, node 4 608A, node 5 610A, node 6 612A, node 7 614A, node 8 616A, and node 9 618A corresponds to element 1 602A, element 2 604A, element 3 606A, element 4 608A, element 5 610A, element 6 612A, element 7 614A, element 8 616A, and element 9 618A, respectively. As the user implements changes to the design of FIG. 6A through the changes 650A, 660A, 670A and 680A of FIG. 6A, corresponding types of design relations 650B, 660B, 670B and 680B are inferred. The types of design relations 650B, 660B, 670B and 680B are stored as edges between nodes 602B, 604B, 606B, 608B, 610B, 612B, 614B and 616B in a knowledge graph.

FIG. 6C provides an example diagram of an example design showing changes to an element of the design FIG. 6A and applying the inferred types of design relations from FIG. 6B in response to the changes to the design, in accordance with embodiments of the present disclosure. As described herein, automatically applying changes based on the inferred types of design relations in response to changes of the design is performed in an efficient and effective manner. Diagram 600C is an example diagram showing automated application of inferred types of design relations in response to change to elements of the design of diagram 600A of FIG. 6A.

As shown, as the user moves element 1 602C (e.g., element 1 602A of FIG. 6A), corresponding changes are applied to each of the elements 604C, 606C, 608C, 610C, 612C, 614, 616C and 618C based on the type of design relation 650C, 660C, 670C and 680C (e.g., 650B, 660B, 670B and 680B of FIG. 6B, respectively) stored in the knowledge graph.

In some embodiments, classifying edges as class edges based on the type of design relation eliminates cyclic relationships. For example, as the user moves element 1 602C (e.g., element 1 602A of FIG. 6A), and corresponding changes are applied to each of the elements 604C, 606C, 608C, 610C, 612C, 614, 616C and 618C, the cycle of applying changes reaches element 1 602C. In this regard, upon encountering the element changed by the end user (e.g., element 1 602C), the loop (e.g., cycle) of apply corresponding changes is exited (e.g., poor man's cycle breaking).

FIG. 6D provides an example diagram showing an order in which the inferred types of design relations are applied in the example diagram of FIG. 6C, in accordance with embodiments of the present disclosure. In embodiments where there are multiple design relations between multiple elements, a breadth first traversal algorithm can be used to apply each corresponding change based on each design relation to all elements affected by a change to a design. For example, following a change (e.g., corresponding to the change to element 1 602C of FIG. 6C) to a first element 602D (e.g., level 0 620D), corresponding changes are applied to a first set of elements connected to the first element based on the design relations between the first element and the first set of elements (e.g., at level 1 621D, changes are applied to elements 604D, 606D, 608D and 614D based on the relationship of the elements to element 602D). In this regard, the corresponding changes to the first set of elements are evaluated in their entirety before proceeding to subsequent changes. Subsequently, corresponding changes are applied to a second set of elements connected to the first set of elements based on the design relations between the first set of elements and the second set elements (e.g., at level 2 622D, subsequent changes are applied to elements 618D and 612D based on the relationship of the elements to element 606D and subsequent changes are applied to elements 616D and 618D based on the relationship of the elements to element 614D). In this regard, the corresponding changes to the second set of elements are evaluated in their entirety before proceeding to subsequent changes (e.g., at level 3 623D, subsequent changes are applied to elements 614D and 616D based on the relationship of the elements to element 618D and subsequent changes are applied to elements 612D and 606D based on the relationship of the elements to element 618D). Finally, upon encountering the first element 602D (e.g., at level 4 624D, the first element 602D is encountered based on the relationship of elements 602D and 608D to element 614D and/or the relationship of elements 602D and 604D to element 606D)), the cycle of the algorithm ends (e.g., poor man's cycle breaking).

In some embodiments, where there is a complex mix of pair-wise and categorical relationships in a cycle (e.g., if there are distribute types of design relations in addition to the align types of design relations of FIGS. 6A-C), re-evaluations can become order dependent. In this regard, in order to handle multiple relations in an order agnostic manner, a breadth first traversal algorithm can be used. In this regard, the breadth first traversal of the network (e.g., knowledge graph) collects all class edges as they are encountered (e.g., level 1 621D, level 2 622D, level 3, 623D, level 4 624D, etc.). Each of the types of design relations are re-evaluated for all class edges on the traversed part of the network together (e.g., level 1 621D is re-evaluated before proceeding to level 2 622D). For example, as one moves from element 1 to element at level 1 621D, elements 1 and 2 are re-aligned. When the breadth first traversal reaches element 3, elements 2 and 3 are re-aligned and elements 1, 2 and 3 are also re-distributed at this point. At level 621D, elements 1 and 4 are re-aligned. When the breadth first traversal reaches element 7, elements 4 and 7 are re-aligned and elements 1, 4 and 7 are also re-distributed at this point. The breadth first traversal then proceeds to level 2 622D. At level 2 622D, element 3's updated position re-aligns element 6, which realigns element 9, and redistributes elements 3, 6 and 9. Finally, element 7 and 8 are re-aligned, 8 and 9 are re-aligned, and 7, 8 and 9 are re-distributed. The breadth first traversal then proceeds to level 3 623D. No changes are encountered at level 3 623D. The breadth first traversal then proceeds to level 4 624D. As the breadth first traversal encounters element 1 (e.g., the element that was moved by the user) at level 4 624D, the cycle/loop is ended.

In some embodiments, corresponding changes applied to element based on the type of design relation between the elements may not be compatible. For example, if element 1 602A was resized instead of being moved and align type of design relations and distribute type of design relations cannot be maintained. In this regard, in some embodiment, some types of design relations may be broken in order to reach maximum compliance possible. For example, a higher priority can be given to categorical relations in comparison to pair-wise relations, or vice versa. A higher priority given to categorical relations in comparison to pair-wise relations may result in an alignment type of design relation being broken in favor of maintaining a distribution type of design relation. In some embodiments, the end user and/or software programmer can update the priorities of different types of design relations. In some embodiments, modifier keys can be utilized by the user to maintain and/or break types of design relations dynamically while making changes to the design.

As an example, procedure 1 presents pseudo code describing for an example re-evaluation algorithm:

Procedure 1: Relationship Re-evaluations

```
input : design D with relationship network N and a set of S of elements updated by the
        user
output : updated relationship compliant design D′
begin
    for every element E in set S :
        Consult N to find if E participates in one or more relations
      If E does not have any relation installed :
        exit
      Perform a breadth first traversal of N starting from E , recording all class edges in
        order. Build a collection C of all class edge based graph cuts encountered. Maintain
        priorities (if any) while recording class edges from every node.
      Depending upon the type of user action (position or appearance update) , flag (or
        mark) available cuts (in C) that do not need re-evaluation
  For every unflagged cut U in C :
        Find if U indirectly affects a flagged cut in C . in that case, unflag that cut.
      Filter all unflagged cuts from C into C′ .
          Maintain that all cuts are still in order of breadth first traversal.
      For every relation R in C′ :
        Re-evaluate R and record it in updated design D′
      Return D′
end
```

FIGS. 7A-7B, 8A-8E, and 9A-9D provide exemplary schematic screenshots from a personal computing device showing aspects of example graphical user interfaces (GUIs), in accordance with embodiments described herein. Aspects of the GUIs depicted in 7A-7B, 8A-8E, and 9A-9D may be determined and presented as described in connection with the components of system 200 of FIG. 2. With reference to FIGS. 7A-7B, 8A-8E, and 9A-9D, various aspects of exemplary schematic screen displays 700A, 700B, 800A, 800B, 800C, 800D, 800E, 900A, 900B, 900C, and 900D are shown, which each can be presented through a display of a computing device, such as user device 102, as discussed above with respect to FIG. 1.

FIG. 7A provides an exemplary schematic screenshot from a personal computing device showing aspects of example graphical user interfaces with an example design showing automated inferred types of design relations between elements with respect to font attributes in order to apply the inferred types of design relations in response to changes to the design, in accordance with embodiments of the present disclosure. As described herein, such inferred types of design relations between elements can be used to automatically apply changes based on the inferred types of design relations in response to changes of the design in an efficient and effective manner.

Example schematic screenshot 700A shows an example design in an example design application. As shown, a user selects elements 702A, 704A, 706A, 708A, and 710A. The user selects a font 712A to be applied to each of the selected elements 702A, 704A, 706A, 708A, and 710A. The selected font 712A is then applied to each of the selected elements 702A, 704A, 706A, 708A, and 710A. A type of design relation between each of the elements is inferred based on the selection of the font for the elements. In embodiments, the elements are stored as nodes in knowledge graph and the type of design relation is stored as an edge between the elements.

FIG. 7B provides an exemplary schematic screenshot from a personal computing device showing aspects of example graphical user interfaces with the example design of FIG. 7A showing applying the inferred types of design relations from FIG. 7A in response to changes to the design, in accordance with embodiments of the present disclosure. Example schematic screenshot 700B shows an example design in an example design application with the inferred types of design relation stored for elements as described with respect to FIG. 7A.

As shown in FIG. 7B, a user selects one of the elements 702B (e.g., corresponding to 702A of FIG. 7A). The user selects a font 712B to apply to element 702B. Following the change to the font of element 702B, the font is automatically applied to each of the elements 704B, 706B, 708B and 710B (e.g., corresponding to 704A, 706A, 708A and 710A, respectively) based on the type of design relation stored between the elements as described with respect to FIG. 7A.

FIGS. 8A-C provide exemplary schematic screenshots from a personal computing device showing aspects of example graphical user interfaces with an example design showing automated inferred types of design relations between elements with respect to position/assembly in order to apply the inferred types of design relations in response to changes to the design, in accordance with embodiments of the present disclosure. As described herein, such inferred types of design relations between elements can be used to automatically apply changes based on the inferred types of design relations in response to changes of the design in an efficient and effective manner.

Example schematic screenshot 800A, 800B and 800C shows an example design in an example design application. As shown in exemplary schematic screenshot 800A, a user selects each of the elements of 802A. The user selects center distribute 804A to distribute each of the elements of 802A with respect to the center of each of the elements of 802A. The user also selects vertical left align 806A to vertically align the left edge of each of the elements of 802A. A center distribute type of design relation and a vertical left align type of design relation is inferred for the elements of 802A based on the selection of center distribute and vertical left align. In embodiments, the elements are stored as nodes in knowledge graph and the types of design relations are stored as an edge between the elements.

As shown in exemplary screenshot 800B, a user selects each of the elements of 802B. The user selects center distribute 804B to distribute each of the elements of 802B with respect to the center of each of the elements of 802B. The user also selects vertical right align 806B to vertically align the right edge of each of the elements of 802B. A center distribute type of design relation and a vertical right align type of design relation is inferred for the elements of 802B based on the selection of center distribute and vertical right align. In embodiments, the elements are stored as nodes in knowledge graph and the types of design relations are stored as an edge between the elements.

As shown in exemplary screenshot 800C, a user selects each of the elements of 802C. The user selects horizontal center align 804C to horizontally align the center of each of the elements of 802C. A horizontal center align type of design relation is inferred for the elements of 802C based on the selection of horizontal center align. In embodiments, the elements are stored as nodes in knowledge graph and the type of design relation is stored as an edge between the elements.

FIGS. 8D-E provide exemplary schematic screenshots from a personal computing device showing aspects of example graphical user interfaces with the example design of FIGS. 8A-C showing applying the inferred types of design relations from FIGS. 8A-C in response to changes to the design, in accordance with embodiments of the present disclosure. As described herein, automatically applying changes based on the inferred types of design relations in response to changes of the design is performed in an efficient and effective manner.

Example schematic screenshot 800D and 800E shows an example design (e.g., the design as shown in example schematic screenshots 800A, 800B and 800C of FIGS. 8A-8C) in an example design application. As shown in exemplary schematic screenshot 800D, a user selects element 802D and moves element 802D. In exemplary schematic screenshot 800E, corresponding changes are applied to the remaining elements based on the types of design relations inferred as described with respect to FIGS. 8A-8C.

FIGS. 9A-B provide exemplary schematic screenshots from a personal computing device showing aspects of example graphical user interfaces with an example design showing automated inferred types of design relations between elements with respect to color in order to apply the inferred types of design relations in response to changes to the design, in accordance with embodiments of the present disclosure. As described herein, such inferred types of design relations between elements can be used to automatically apply changes based on the inferred types of design relations in response to changes of the design in an efficient and effective manner.

Example schematic screenshot 900A and 900B shows an example design in an example design application. As shown in exemplary schematic screenshot 900A, a number of drawings 902A, 904A are presented. In exemplary schematic screenshot 900B, a user selects a color for the number of drawings 902B, 904B, which updates each of the drawings with the selected color (e.g., the color of the drawings as presented as 902A and 904A of FIG. 9A are changed to the color of the drawings as presented as 902B and 904B of FIG. 9B). For example, in the example shown in FIG. 9B, the user selects a color theme picker 906B to change the colors of the drawings to a specific color theme. A color type of design relation is inferred for the drawings 902B, 904B based on the user implemented change in color to the drawings. In embodiments, the drawings (e.g., elements) are stored as nodes in knowledge graph and the type of design relation is stored as an edge between the elements.

FIGS. 9C-D provide exemplary schematic screenshots from a personal computing device showing aspects of example graphical user interfaces with the example design of FIGS. 9A-B showing applying the inferred types of design relations from FIGS. 9A-B in response to changes to the design, in accordance with embodiments of the present disclosure. As described herein, automatically applying changes based on the inferred types of design relations in response to changes of the design is performed in an efficient and effective manner.

Example schematic screenshot 900C and 900D shows an example design (e.g., the design as shown in example schematic screenshots 900A and 900B of FIGS. 9A-9B) in an example design application. As shown in exemplary schematic screenshot 900C, a user selects element 902C and changes the color of element 902C. In exemplary schematic screenshot 900D, corresponding changes are applied to the remaining elements based on the types of design relations inferred as described with respect to FIGS. 9A-9B.

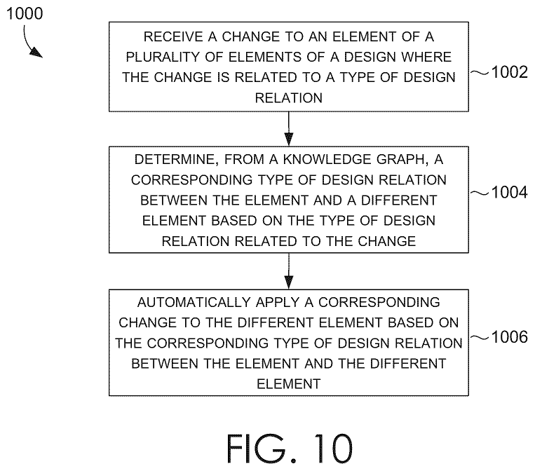

With reference now to FIGS. 10-12, FIGS. 10-12 provide method flows related to facilitating automated inference and evaluation of design relations for elements of a design, in accordance with embodiments of the present technology. Each block of method 1000, 1100 and 1200 comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few. The method flows of FIGS. 10-12 are exemplary only and not intended to be limiting. As can be appreciated, in some embodiments, method flows 1000-1200 can be implemented, at least in part, to facilitate automated inference and evaluation of design relations for elements of a design.

Turning now to FIG. 10, a flow diagram 1000 is provided showing an embodiment of a method 1000 for automated inference and evaluation of design relations for elements of a design, in accordance with embodiments described herein. Initially, at block 1002, a change to an element of a plurality of elements of a design is received where the change is related to a type of design relation. In some embodiments, the change includes, but is not limited to, movement of the element, changing appearance of the element, changing size of the element, changing stroke-width of the element, changing stroke-alignment (inside, central, outside, and/or etc.) of the element, changing a style of an end point of a line of the element (e.g., round-cap, etc.), changing a style of how a line of the element changes direction (e.g., bevel-join, round-join, etc.), changing a point of alignment of the element (e.g., anchor-alignment, etc.), and/or any other types of changes. The examples of changes are exemplary only and not intended to be limiting.

At block 1004, a corresponding type of design relation between the element and a different element of the plurality of elements is determined from a knowledge graph based on the type of design relation related to the change. In some embodiments, the type of design relation is an assembly design relation corresponding to at least one of an align type of design relation and a distribute type of design relation. In some embodiments, the type of design relation is an appearance design relation corresponding to at least one of color, font size, font effects, font style, and underline. In some embodiments, the type of design relation is a markup design relation corresponding to at least one of a linear measurement and an angular measurement. In some embodiments, each element of the plurality of elements is stored as a node in the knowledge graph and each type of design relation is stored as an edge in the knowledge graph between one or more elements of the plurality of elements. In this regard, each edge is classified according to a corresponding type of design relation.

At block 1006, a corresponding change is automatically applied to the different element based on the corresponding type of design relation between the element and the different element. For example, if a user moves an element and the element includes an alignment type of design relation with a different element, the different element would automatically be aligned with the element as moved.

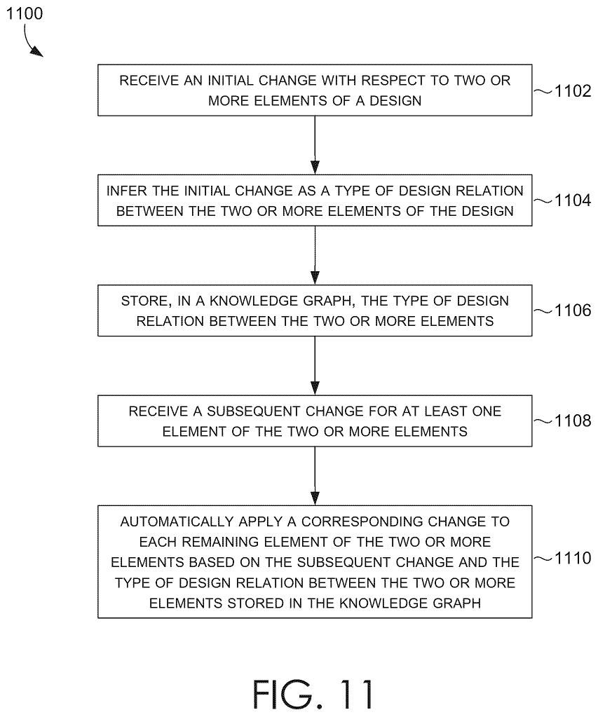

Turning now to FIG. 11, a flow diagram 1100 is provided showing an embodiment of a method 1100 for automated inference and evaluation of design relations for elements of a design, in accordance with embodiments described herein. Initially, at block 1102, an initial change with respect to two or more elements of a design is received. In some embodiments, the initial change corresponds to aligning the two or more elements, distributing the two or more elements, matching appearance of the two or more elements, and/or providing a measurement between the two or more elements.

At block 1104, a type of design relation is inferred based on the initial change between the two or more elements of the design. At block 1106, the type of design relation between the two or more elements is stored in a knowledge graph. At block 1108, a subsequent change for at least one element of the two or more elements is received. In some embodiments, the subsequent change corresponds to movement of the element, changing appearance of the element, and/or changing size of the element. At block 1110, a corresponding change is automatically applied to each remaining element of the two or more elements based on the subsequent change and the type of design relation between the two or more elements stored in the knowledge graph.

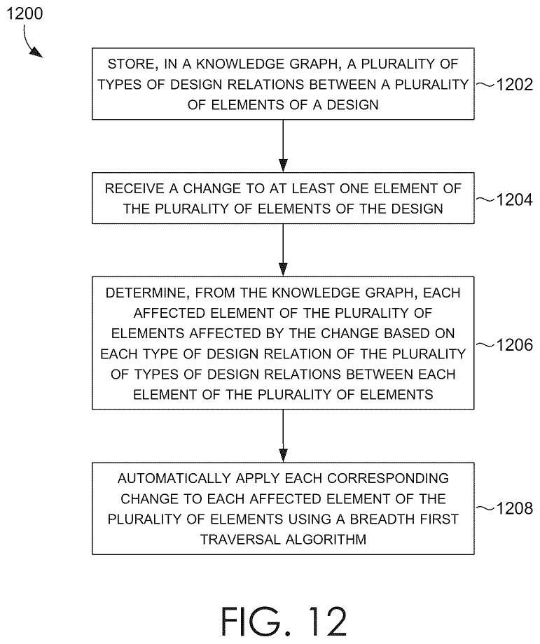

Turning now to FIG. 12, a flow diagram 1200 is provided showing an embodiment of a method 1200 for automated inference and evaluation of design relations for elements of a design, in accordance with embodiments described herein. Initially, at block 1202, a plurality of types of design relations between a plurality of elements of a design is stored in a knowledge graph. At block 1204, a change to at least one element of the plurality of elements of the design is received. At block 1206, each affected element of the plurality of elements affected by the change is determined from the knowledge graph based on each type of design relation of the plurality of types of design relations between each element of the plurality of elements.

At block 1208, each corresponding change is automatically applied to each affected element of the plurality of elements using a breadth first traversal algorithm. In some embodiments, the process of using the breadth first traversal algorithm is performed by automatically applying a first set of corresponding changes to a first set of elements of the plurality of elements based on a first set of design relations between the first set of elements and the at least one element. Subsequent to automatically applying the first set of corresponding changes to the first set of elements, a second set of corresponding changes is automatically applied to a second set of elements of the plurality of elements based on a second set of design relations between the second set of elements and the first set of elements. In some embodiments, when a change to an affected element conflicts with a different change of a different affected element, the change based on a type of design relation is applied and the change based on the type of design relation with a lower priority is rendered invalid.

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 13 in particular, an exemplary operating environment for implementing aspects of the technology described herein is shown and designated generally as computing device 1300. Computing device 1300 is just one example of a suitable computing environment and is not intended to suggest any limitation as to the scope of use or functionality of the technology described herein. Neither should the computing device 1300 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 13, computing device 1300 includes a bus 1310 that directly or indirectly couples the following devices: memory 1312, one or more processors 1314, one or more presentation components 1316, input/output (I/O) ports 1318, I/O components 1320, an illustrative power supply 1322, and a radio(s) 1324. Bus 1310 represents what may be one or more busses (such as an address bus, data bus, or combination thereof). Although the various blocks of FIG. 13 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 13 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 13 and refer to “computer” or “computing device.”

Computing device 1300 typically includes a variety of computer-readable media. Computer-readable media can be any available media that can be accessed by computing device 1300 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1312 includes computer storage media in the form of volatile and/or nonvolatile memory. The memory 1312 may be removable, non-removable, or a combination thereof. Exemplary memory includes solid-state memory, hard drives, and optical-disc drives. Computing device 1300 includes one or more processors 1314 that read data from various entities such as bus 1310, memory 1312, or I/O components 1320. Presentation component(s) 1316 present data indications to a user or other device. Exemplary presentation components 1316 include a display device, speaker, printing component, and vibrating component. I/O port(s) 1318 allow computing device 1300 to be logically coupled to other devices including I/O components 1320, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 1314 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 1300. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 1300. The computing device 1300 may be equipped with depth cameras, such as stereoscopic camera systems, infrared camera systems, RGB camera systems, and combinations of these, for gesture detection and recognition. Additionally, the computing device 1300 may be equipped with accelerometers or gyroscopes that enable detection of motion. The output of the accelerometers or gyroscopes may be provided to the display of the computing device 1300 to render immersive augmented reality or virtual reality.

A computing device may include radio(s) 1324. The radio 1324 transmits and receives radio communications. The computing device may be a wireless terminal adapted to receive communications and media over various wireless networks. Computing device 1300 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

What is claimed is:

1. A computer-implemented method comprising:
receiving a change to an element of a plurality of elements of a design, the change related to a type of design relation;
determining, from a knowledge graph, a corresponding type of design relation between the element and a different element of the plurality of elements based on the type of design relation related to the change; and
automatically applying a corresponding change to the different element based on the corresponding type of design relation between the element and the different element.

2. The computer-implemented method of claim 1, further comprising:
receiving an initial set of changes with respect to a number of elements of the plurality of elements of the design;
inferring the initial set of changes as a corresponding set of types of design relations between the number of elements of the plurality of elements of the design; and
storing, in the knowledge graph, the number of elements as corresponding nodes in the knowledge graph and the corresponding set of types of design relations as corresponding edges between the corresponding nodes in the knowledge graph, each corresponding edge classified according to the corresponding type of design relation.

3. The computer-implemented method of claim 2, wherein the change is related to a number of types of design relations, the method further comprising:
identifying each corresponding type of design relation from the corresponding set of types of design relations related to the change;
determining, from the knowledge graph, a set of elements from a set of corresponding nodes, each corresponding node of the set of corresponding nodes connected by each edge corresponding to each corresponding type of design relation from the corresponding set of types of design relations related to the change; and
automatically applying a set of corresponding changes to the set of elements based on the change to the element.

4. The computer-implemented method of claim 3, wherein the set of corresponding changes are automatically applied to the set of elements using a breadth first traversal algorithm.

5. The computer-implemented method of claim 4, wherein the breadth first traversal algorithm is ended upon re-encountering the element during the breadth first traversal algorithm.

6. The computer-implemented method of claim 1, further comprising:
responsive to receiving a subsequent change to the element while simultaneously receiving selection of a modifier key, automatically deleting the corresponding type of design relation between the element and the different element in the knowledge graph.

7. The computer-implemented method of claim 1, wherein the change is at least one of movement of the element, changing appearance of the element, changing size of the element, changing stroke-width of the element, changing stroke-alignment of the element, changing a style of an end point of the element, changing a style of how the element changes direction and changing a point of alignment of the element; and wherein the type of design relation at least one of an align, a distribute, color, font size, font effects, font style, underline, linear measurement and angular measurement.

8. One or more computer-readable media having a plurality of executable instructions embodied thereon, which, when executed by one or more processors, cause the one or more processors to perform a method comprising:
receiving an initial change with respect to two or more elements of a design;
inferring the initial change as a type of design relation between the two or more elements of the design;
storing, in a knowledge graph, the type of design relation between the two or more elements;
receiving a subsequent change for at least one element of the two or more elements; and
automatically applying a corresponding change to each remaining element of the two or more elements based on the subsequent change and the type of design relation between the two or more elements stored in the knowledge graph.

9. The media of claim 8, further comprising:
receiving an initial set of changes with respect to a number of elements of a plurality of elements of the design;
inferring the initial set of changes as a corresponding set of types of design relations between the number of elements of the plurality of elements of the design; and
storing, in the knowledge graph, the number of elements as corresponding nodes in the knowledge graph and the corresponding set of types of design relations as corresponding edges between the corresponding nodes in the knowledge graph, each corresponding edge classified according to the corresponding type of design relation.

10. The media of claim 9, further comprising:
identifying each corresponding type of design relation from the corresponding set of types of design relations related to the subsequent change;
determining, from the knowledge graph, a set of elements from a set of corresponding nodes, each corresponding node of the set of corresponding nodes connected by each edge corresponding to each corresponding type of design relation from the corresponding set of types of design relations related to the subsequent change; and
automatically applying a set of corresponding changes to the set of elements based on the subsequent change to the at least one element.

11. The media of claim 10, wherein the set of corresponding changes are automatically applied to the set of elements using a breadth first traversal algorithm.

12. The media of claim 11, wherein the breadth first traversal algorithm is ended upon re-encountering the element during the breadth first traversal algorithm.

13. The media of claim 8, further comprising:
responsive to receiving a further subsequent change to the element while simultaneously receiving selection of a modifier key, automatically deleting the type of design relation between the two or more elements in the knowledge graph.

14. The media of 8, wherein the initial change is at least one of aligning the two or more elements, distributing the two or more elements, matching appearance of the two or more elements, and providing a measurement between the two or more elements; wherein the subsequent change is at least one of movement of the at least one element, changing appearance of the at least one element, and changing size of the at least one element; and wherein the type of design relation at least one of an align, a distribute, color, font size, font effects, font style, underline, linear measurement, and angular measurement.

15. A computing system comprising:
a processor; and
a non-transitory computer-readable medium having stored thereon instructions that when executed by the processor, cause the processor to perform operations including:
storing, in a knowledge graph, a plurality of types of design relations between a plurality of elements of a design;
receiving a change to an element of the plurality of elements of the design;
identifying each type of design relation from the plurality of types of design relations related to the change;
determining, from the knowledge graph, each related element of the plurality of elements related to each identified type of design relation from the plurality of types of design relations related to the change;
automatically applying each corresponding change to each related element of the plurality of elements using a breadth first traversal algorithm.

16. The system of claim 15, wherein the instructions that when executed by the processor, cause the processor to perform operations further including:
receiving an initial set of changes with respect to the plurality of elements of the design;
inferring the initial set of changes as the plurality of types of design relations between the plurality of elements of the design; and
storing, in the knowledge graph, the plurality of elements as corresponding nodes in the knowledge graph and the plurality of types of design relations as corresponding edges between the corresponding nodes in the knowledge graph, each edge is classified according to the each type of design relation of the plurality of types of design relations.

17. The system of claim 15, wherein automatically applying each corresponding change to each related element of the plurality of elements using the breadth first traversal algorithm further comprises:
automatically applying a first set of corresponding changes to a first set of elements of the plurality of elements based on a first set of types of design relations between the first set of elements and the element; and
subsequent to automatically applying the first set of corresponding changes to the first set of elements, automatically applying a second set of corresponding changes to a second set of elements of the plurality of elements based on a second set of types of design relations between the second set of elements and the first set of elements.

18. The system of claim 15, wherein the breadth first traversal algorithm is ended upon re-encountering the element during the breadth first traversal algorithm.

19. The system of claim 15, further comprising:
responsive to receiving a subsequent change to the element while simultaneously receiving selection of a modifier key, automatically deleting each type of design relation directly between the element and other elements of the plurality of elements.

20. The system of claim 15, wherein the instructions that when executed by the processor, cause the processor to perform operations further including:
for each corresponding change to each related element that conflicts with a different corresponding change, applying each corresponding change of a corresponding type of design relation with a higher priority.
